(19) United States
(12) Patent Application Publication
(10) Pub. No.: US 2016/0236043 A1
(43) Pub. Date: Aug. 18, 2016

(54) DEVICE FOR RECEIVING IMPACTS, COMPRISING INNER PIEZOELECTRIC ENERGY RECOVERY MEANS

(71) Applicant: COMMISSARIAT A L'ENERGIE ATOMIQUE ET AUX ENERGIES ALTERNATIVES, Paris (FR)

(72) Inventors: Guillaume Savelli, Grenoble (FR); Philippe Coronel, Barruax (FR); Chloé Guerin, Grenoble (FR)

(21) Appl. No.: 15/023,214

(22) PCT Filed: Jul. 28, 2014
(86) PCT No.: PCT/FR2014/051951

§ 371 Date: Mar. 18, 2016

(30) Foreign Application Priority Data
Sep. 25, 2013 (FR) 1359232

(51) Int. Cl. A63B 43/00; H02N 2/18; A63B 39/00

(52) U.S. Cl. CPC A63B 43/004; A63B 39/00; H02N 2/183; A63B 2039/006

(57) ABSTRACT

A device includes a deformable shell that defines an inner space under a gas pressure higher than the atmospheric pressure. A flexible piezoelectric membrane is applied against an inner wall of the deformable shell under the effect of the pressure present in the inner space. The membrane is capable of generating electric energy under the effect of a deformation of the shell. An electric circuit is electrically connected to the piezoelectric membrane and includes an element for storing the electric energy that it generates and a rigid structure. Longilineal resilient elements for holding the electric circuit according to a predetermined position of the inner space are each arranged between the rigid structure of the electric circuit and the inner wall of the deformable shell and secured to the piezoelectric membrane and to the rigid structure.

### CROSS-REFERENCE TO RELATED APPLICATIONS

This application is a national stage application under 35 U.S.C. §371 and claims the benefit of priority of international application no. PCT/FR2014/051951, filed Jul. 28, 2014, which claims the benefit of priority under 35 U.S.C. §119 of French patent application no. 1359232, filed Sep. 25, 2013, and the entire contents of each is hereby incorporated herein by reference, in its entirety and for all purposes.

### TECHNOLOGICAL FIELD

The present disclosure relates to the functionalization of balls, particularly pressurized deformable balls, especially in the field of sports and/or of physical restoration, such as, for example, tennis balls.

### BACKGROUND OF THE DISCLOSURE

In ball sports and physical restoration based on such objects, it is useful to have statistics enabling the players to analyze their play and the medical staff to assess the quality of the exercises practiced by the patients. Usually, such statistics are manually collected by, for example, counting the number of hits, bounces, or others that a player or a patient exerts on a ball during a determined time period.

Further, certain sports consume a large quantity of balls, the latter having a limited life-time, and the balls need to be recycled, which generates a non-negligible cost. The French Tennis Federation thus estimates to more than one million the number of tennis balls consumed yearly in the various tennis clubs and schools on the French territory.

It is also advantageous to integrate in balls electronic functions enabling to automatically make statistics and/or to convert into electric energy and store the mechanical energy provided to these objects during the use thereof.

Document US 2011/136603 discloses a sports ball comprising a deformable shell defining a pressurized inner space, such as for example a tennis ball, and comprising an energy recovery circuit based on a piezoelectric material, which converts into electric energy part of the mechanical energy received by the shell under the effect of the deformation thereof by an impact, and which stores the electric energy thus generated in a battery internal to the ball. The energy thus recovered and stored is used by a circuit internal to the ball, such as for example, an accelerometer, a pressure sensor, or a GPS system.

This document however says nothing of the means for integrating such electric elements into the ball to hinder as little as possible the aerodynamics and the deformations thereof. Indeed, the functionalized ball should be substantially identical to conventional balls in order to be used in their place, particularly in sports, where balls must fulfill very strict criteria to be deemed conformal. Moreover, this document says nothing either of what happens with the circuits embarked in balls once said balls are worn out.

### SUMMARY OF THE DISCLOSURE

The present disclosure provides various embodiments of a device with a deformable shell defining a pressurized inner space which comprises electric circuits implementing at least an energy conversion and storage function, which has an operation substantially identical to that of a device comprising no such circuits, and having easily-recyclable electric circuits once the device is out of use.

To achieve this, the disclosed embodiments describe a deformable shell defining an inner space under a gas pressure higher than the atmospheric pressure. A flexible piezoelectric membrane, applied against an inner wall of the deformable shell under the effect of the pressure present in the inner space, is capable of generating electric energy under the effect of a deformation of the shell. An electric circuit electrically connected to the piezoelectric membrane, includes an element for storing the electric energy that it generates and a rigid structure. Longilineal resilient elements for holding the electric circuit according to a predetermined position of the inner space, are each arranged between the rigid structure of the electric circuit and the inner wall of the deformable shell and secured to the piezoelectric membrane and to the rigid structure.

“Deformable” here means a shell capable of deforming under the effect of impacts to which it is submitted during a standard use of the shell. Conversely, “rigid” means an element which does not substantially deform during said use.

In other words, the piezoelectric material takes the form of a membrane, usually very thin, having a thickness smaller than one millimeter, applied against the shell. As compared with shell thicknesses usually observed for balls, typically a few millimeters, the presence of the piezoelectric membrane thus does not alter the general properties of these objects.

Further, the internal electric circuit is held in place, particularly at the center of a spherical ball, by resilient elements exerting pull-back forces towards this position and capable of following the deformation undergone by the outer shell under the effect of impacts. First, the electric circuit held in an appropriate position disturbs as little as possible the operation of the object, particularly by leaving the center of gravity unchanged. Further, by adopting non-rigid holding elements, the shell deformation properties also remain unchanged. Indeed, if rigid holding elements were adopted, the shell would be effectively less deformable, and thus impossible to use in certain sports, such as tennis, for example, for which the significant deformation of the ball is essential for the game.

Finally, the assembly formed by the membrane, the electric circuit, and the holding elements is easily extractible from the shell. Indeed, once it has been ripped open, for example, to be recycled, the disappearing of the overpressure results in a separation of the piezoelectric membrane from the shell. This assembly can then easily be recovered and may be used again in another shell, the pressurizing of the inner space of the shell pressing of the membrane against the inner wall thereof.

According to an embodiment, the holding elements comprise springs compressed between the rigid structure of the electric circuit and the inner wall of the deformable shell. Springs indeed have the advantage of requiring a limited volume of matter to efficiently implement a pull-back force, and thus disturb as little as possible the operation of the device.

According to an embodiment, the deformable shell defines a tennis ball, where the predetermined position is the center of the tennis ball, where the electric circuit is inscribed within a spherical volume concentric to the tennis ball and having a diameter smaller than half the inner diameter of the deformable shell, and where the holding elements are deformable with no deterioration over approximately at least one third of the length that they have when the ball is submitted to no deformation. Indeed, during a game, a tennis ball undergoes deformations capable of reaching one third of its diameter. The useful volume of a tennis ball where the electric circuit can be housed with no risk of coming into contact with the deformed shell is thus limited to a very small sphere. By providing an electric circuit contained within this sphere and holding elements capable of significantly deforming, the tennis ball can thus be submitted to the required extreme deformations with no risk of deteriorating or destroying the electric circuit.

According to an embodiment, the piezoelectric membrane comprises a polyvinylidene fluoride or lead zirconium titanium. Particularly, the film has a thickness in the range from 10 micrometers to 200 micrometers. The membrane is thus light, flexible, and mechanically robust.

According to an embodiment, the electric energy storage element comprises a microbattery formed on a flexible or rigid substrate. This type of electric energy storage means is very light, usually with a low weight and surface area for a large storage capacity.

According to an embodiment, the holding elements are formed of springs, particularly made of steel, stainless or not, particularly AlSl302 or AlSl316 stainless steel, of a nickel and chromium alloy, for example, inconel® 600, 625, or 718, of copper, or of beryllium.

According to an embodiment, at least two of the holding elements are electrically conductive and form two electric connections between the piezoelectric membrane and the electric circuit for the transmission of the electric energy generated by the membrane to the electric circuit. It is thus not necessary to provide other types of electric connection, such as, in particular, welded wires. Further, such connections are robust.

According to an embodiment, the electric circuit is formed of parallelepipedal electric stages arranged in parallel in a rigid frame. This type of configuration provides a compact circuit, which thus only very little disturbs the operation of a ball.

According to an embodiment, the electric circuit comprises a circuit for generating data from the electric energy generated by the piezoelectric membrane, and a circuit of wireless transmission of said data outside of the deformable shell, said generation and transmission circuits being powered by the electric energy storage element. The data generation circuit is in particular capable of counting the number of electric pulses generated by the piezoelectric membrane and/or the data generation circuit is capable of determining a wearing state of the device according to the number of counted pulses. Advantageously, the electric circuit comprises a circuit connected to the electric energy storage element and comprising an electric interface for the connection to an external circuit for recovering the energy stored in the element when the device is open.

The described embodiments also provide a device intended to be integrated in an inner space of a deformable shell taken to a pressure higher than the atmospheric pressure. The device includes a flexible piezoelectric membrane capable of generating electric energy under the effect of mechanical stress. An electric circuit electrically connected to the piezoelectric membrane includes an element for storing the electric energy that it generates and a rigid structure. Longilineal resilient elements for securing the rigid structure of the electric circuit are secured to the piezoelectric membrane.

The described embodiments further provide a method of manufacturing a device that includes a deformable spherical shell defining an inner space under a gas pressure higher than the atmospheric pressure. The method includes forming a first and a second deformable half-shells, and forming an assembly comprising the piezoelectric membrane, the electric circuit, and the holding elements, the length of the holding elements being selected so that the latter are compressed when the assembly is housed in the deformable shell. The method also includes inserting the assembly into the first half-shell, placing the second half-shell on the first half-shell to form the deformable shell, and pressurizing the inner space of the shell to apply the piezoelectric membrane against the inner wall of the deformable shell.

### BRIEF DESCRIPTION OF THE DRAWINGS

The presently described embodiments will be better understood on reading of the following description provided as an example only in relation with the accompanying drawings, where:

FIG. 1 is a simplified cross-section view of a tennis ball;

FIG. 2 is a simplified perspective view of a portion of the flexible piezoelectric membrane and of the holding elements of FIG. 1;

FIG. 3 is a simplified cross-section view of the piezoelectric membrane of FIG. 1;

FIG. 4 is a simplified perspective view of the circuit and of the electric holding elements of FIG. 1;

FIG. 5 is a simplified perspective view of the circuit and of the electric holding elements according to an embodiment;

FIGS. 6 and 7 are simplified views of the holding elements according to two embodiments;

FIGS. 8, 9, and 10 are simplified views of electric connections between the piezoelectric membrane and the electric circuit of FIG. 1 according to a plurality of embodiments;

FIGS. 11 to 14 are simplified cross-section views illustrating a method of manufacturing the tennis ball of FIG. 1; and

FIG. 15 is a simplified cross-section view of another embodiment applied to an object having a flexible shell.

### DETAILED DESCRIPTION

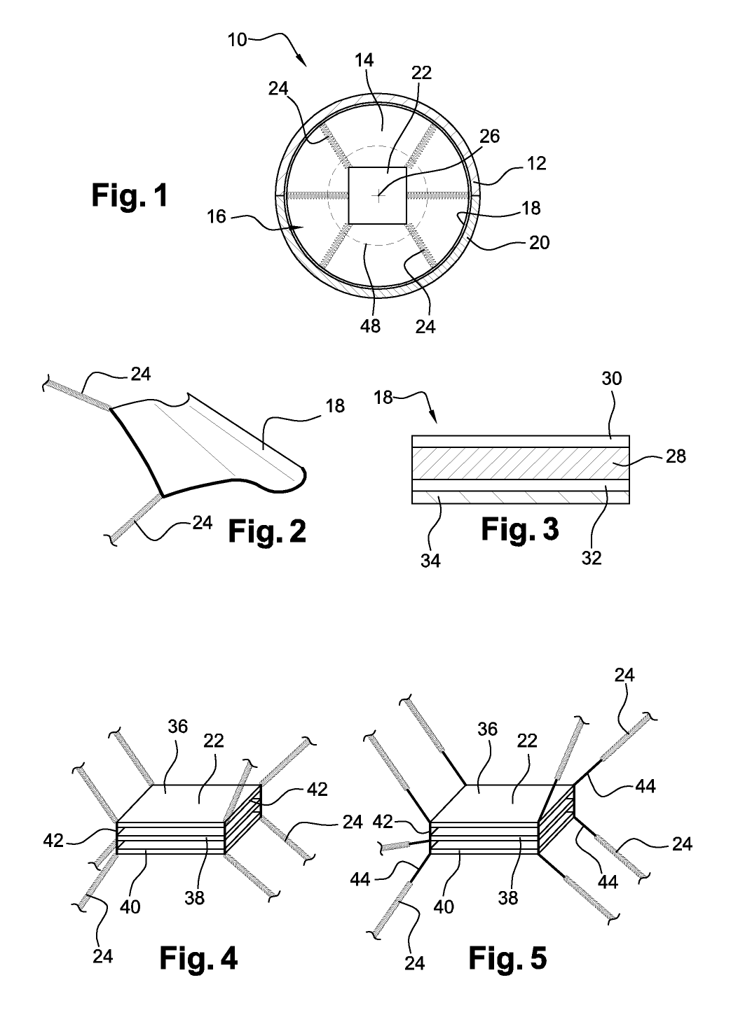

A tennis ball 10 according to the present disclosure will now be described in relation with FIGS. 1 to 8. Tennis ball 10 comprises a deformable shell 12, for example, made of rubber, defining a hollow inner space 14 filled with air under a pressure higher than the atmospheric pressure, especially a pressure in the order of 2 bars.

More specifically referring to FIG. 1, tennis ball 10 comprises in space 14 an energy recovery system 16 comprising: a flexible piezoelectric membrane 18 applied against inner surface 20 of shell 12, advantageously all over said surface, piezoelectric membrane 18 releasing electric charges when it deforms and thus releasing electric charges when shell 12 deforms, for example, under the effect of a hitting or of a bounce of ball 10; an electric circuit 22 comprising an element for converting the electric charges generated by the membrane into a constant current and/or voltage and one or a plurality of elements for storing the electric energy generated by the conversion element, as well as, optionally, an electronic circuit implementing one or a plurality of functions described hereafter; an assembly of holding elements 24 positioning electric circuit 22 at center 26 of ball 10 by implemented pull-back forces towards said position, and capable of deforming in relation with the deformations undergone by shell 12 so as not to oppose them.

As illustrated in FIGS. 2 and 3, piezoelectric membrane 18 comprises: a piezoelectric film 28, having a thickness advantageously in the range from 10 micrometers to 200 micrometers, formed in one piece or in a plurality of pieces. Two metal layers 30, 32, having a thickness in the range from a few nanometers to a few tens of micrometers each, deposited on either side of piezoelectric film 28, for example, made of silver, of copper nitride, of aluminum, and forming two electrodes for collecting the electric charges generated by film 28; optionally, a flexible substrate 34, for example, made of plastic, such as polyethylene terephthalate (“PET”) or polyethylene naphthalate (“PEN”), having the stack of piezoelectric film 28 interposed between metal electrodes 30, 32 formed thereon.

Advantageously, piezoelectric film 28 is made of polyvinylidene fluoride (“PVDF”) which has the advantage of being both light, flexible, and mechanically resistant, metal electrodes 30, 32 being capable of being directly deposited on the film surfaces without using a substrate 34. As a variation, film 28 is made of lead zirconium titanium (“PZT”), of zinc oxide (“ZnO”), or of a composite material of at least two materials from among these and PVDF. Due to the materials used for membrane 18 and to the thickness thereof, the membrane has substantially no influence on the aerodynamic and deformation behavior of ball 10.

Electric circuit 22 is designed to also disturb as little as possible the aerodynamic behavior of ball 10. First, electric circuit 22 is selected to be as light as possible given the functions that it implements. Particularly, the electric power storage element is advantageously formed of a microbattery formed on a flexible or rigid substrate. For example, the storage element is a rigid substrate microbattery from the “EnerChip” range of Cymbet® Corp., for example, a microbattery bearing reference “CBC050-M8C” having a 8×8 mm² surface area for a 50 μAh capacity, or a Solicore®, Inc. flexible substrate microbattery, for example, a microbattery bearing reference “SF-2529-10EC” having a foldable surface of 25.75×29 mm² for a 10-mAh capacity. As a variation, the electric power storage element comprises one or a plurality of capacitors and/or one or a plurality of supercapacitors.

Circuit 22 is also advantageously designed to have the highest possible three-dimensional symmetry, circuit 22 ideally having a spherical shape and a uniform density. However, given usual electric and electronic circuit manufacturing methods, the circuits generally have a parallelepipedal shape. Advantageously, circuit 22 takes the shape of a stack of parallelepipedal circuits, such as illustrated in FIGS. 4 and 5, to obtain a cuboid shape, advantageously a cube.

Circuit 22 thus comprises, in particular: a first stage 36 electrically connected to membrane 18, and converting the charges that the latter generates, essentially in the form of a non-constant current, into a constant current and/or a constant voltage, currently used to charge a microbattery, such as for example a circuit of “LTC3588” type of Linear Technology Corp., a second stage 38, electrically connected to first stage 36, comprising a microbattery charging due to the constant current and/or voltage generated by the first stage, and, optionally, one or a plurality of third stages 40 electrically connected to the battery of second stage 38 for their electric power supply, and implementing one or a plurality of electronic functions as will be described in further detail hereafter, or comprising one or a plurality of additional electric energy storage elements.

The stages are further attached by means of a rigid frame 42 having holding elements 24 fastened thereto.

Holding elements 24 have an longilineal shape, and each of elements 24 is fastened at a first end to electric circuit 22, particularly to frame 42 thereof, and is also fastened to piezoelectric membrane 18.

Elements 24 are fastened to the frame of circuit 22 and to membrane 18 by gluing, by welding, by magnetic contact, by screwing, by a self-locking system, or by means of a quickconnect-type system. As a variation, the fastening is performed by means of a polymer material, such as, for example, a polyurethane, an epoxy glue, an anaerobic glue comprising a mixture of glycol dimethacrylate with a minority quantity of peroxide and setting accelerator, a cyanoacrylate, or an MS polymer mastic based on modified silane. As a variation, the fastening is performed by means of nanofibers, for example, of collagen nanofibers, carbon and copper nanofibers, SiC nanowires comprising carbon microtips.

Energy recovery system 16 formed of membrane 18, of circuit 22, and of holding elements 24 thus forms one and the same object, which facilitates its installation in tennis ball 10 as well as its removal, as will be described in further detail hereafter.

Further, the second end of each of elements 24 rests on inner wall 20 of shell 12 without being secured thereto, which here again allows a simplified installation and removal of system 16. Finally, membrane 18 is fastened to the second end of each of elements 24, so that the second end rests on inner wall 20 through membrane 18, or at least an area close to this end, which eases its deployment and its application on inner wall 20 of shell 12 under the effect of the pressure in inner space 14 of ball 10.

As illustrated in FIG. 4, holding elements 24 are advantageously formed of springs, a spring having a significant pull-back force while being hollow, and thus light. For example, the springs are made of steel, stainless or not, particularly AlSl302 or AlSl316 stainless steel, of a nickel and chromium alloy, for example, inconel® 600, 625, or 718, of copper, or of beryllium.

Further, the springs are selected to be deformable along their main pull-back axis and substantially more rigid perpendicularly to this axis, which eases the placing into contact of their second end with shell 12. In the context of an electric circuit 22 having a parallelepiped shape, there are advantageously eight springs, one spring being provided for each corner of circuit 22. As a variation, as illustrated in FIG. 5, the holding elements also comprise a rigid rod 44, positioned between circuit 22 and the springs, to rigidify system 16 and thus make the latter more mechanically robust. According to an embodiment, holding elements 24 also comprise a piezoelectric material, which also enables to recover energy during the deformation thereof.

Advantageously, circuit 22 has dimensions appropriate for the type of deformation to which the tennis ball is likely to be submitted during its use. A tennis ball is known to be able to deform by one third of its diameter when hit by experienced players. Circuit 22 is thus selected to be inscribed within a sphere 48 (FIG. 1), so that shell 12 cannot come into contact with circuit 22, including when the tennis ball undergoes a significant decrease in its diameter. For example, circuit 22 is inscribed within a sphere having a diameter smaller than half the diameter of tennis ball 10, for example, a sphere having a 3-cm diameter for a standard tennis ball.

Further, holding elements 24 are designed to undergo with no deterioration a compression and an elongation greater than one third of their length when the ball is at rest to follow such extreme deformations.

Holding elements 24 further provide a pull-back force when stretched and/or compressed so that circuit 22 can displace in inner space 14 of the ball without ever impacting inner wall 20 under the effect of violent shocks affecting the ball during a tennis match.

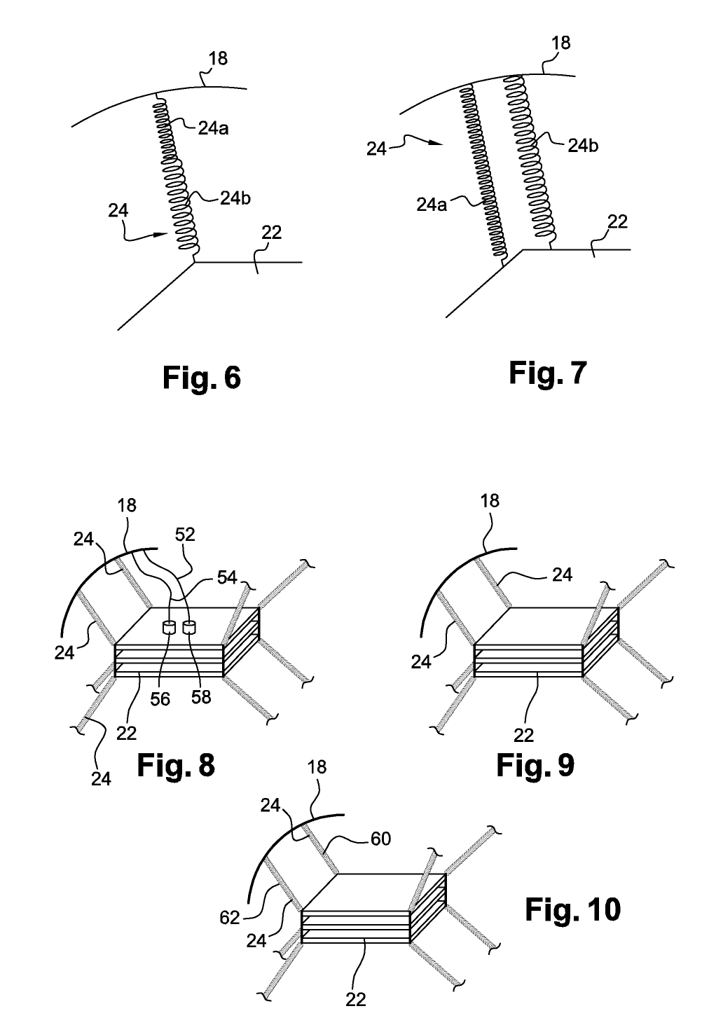

Advantageously, holding elements 24 each comprise a plurality of springs 24a, 24b, for example, 2, connected in series, as illustrated in FIG. 6, or in parallel, as illustrated in FIG. 7, which enables to more easily define a different behavior of elements 24 according to the intensity of the impact received by shell 12. Particularly, by providing a plurality of different springs, it is possible to simply design holding elements 24 which have both a low rigidity, that is, which do not oppose the deformation undergone by shell 12, and a sufficient rigidity, that is, avoiding the collision of circuit 22 on shell 12 during impacts received by shell 12.

FIGS. 8, 9, and 10 illustrate alternative electric connections between piezoelectric membrane 18 and electric circuit 22 to transmit thereto the electric charges generated by the membrane.

According to a first variation illustrated in FIG. 8, the two electrodes 30, 32 of membrane 18 are connected to circuits 22, particularly its constant current/voltage conversion circuit 36, by means of two conductive wires 52, 54 welded to said electrodes and to two pads 56, 58 of circuit 22. In this variation, wires 52, 54 are free of being positioned independently from elements 24 and frame 42.

According to a second variation illustrated in FIG. 9, two of holding elements 24 are electrically conductive and are connected, for example, by welding, to electrodes 30, 32 and to conductive portions of circuit 22 forming the electric inputs of circuit 22, particularly of conversion circuit 36.

According to a third variation, illustrated in FIG. 10, elements 24 are hollow, for example, formed of springs, and the connection is formed by two conductive wires 60, 62 housed in two of elements 24, and fastened, for example, by welding, to electrodes 30, 32 of membrane 18 and circuit 22, for example, to pads thereof or to conductive portions of frame 42 forming electric inputs of circuit 22, particularly conversion circuit 36.

The first variation has the advantage of enabling to select a frame independent from the connection between the membrane and circuit 22. However, the wires are fully submitted to the accelerations of the ball on impacts thereof, which fragilizes them.

The second variation conversely provides connections which are little sensitive to said accelerations, but requires on the other hand a more complex frame for circuit 22.

The third variation show a compromise between the first two variations, where the wires are protected by elements 24 and the connection to circuit 22 may be independent from the frame, for example, by providing a wire portion arranged outside of elements 24 for a connection to pads of circuit 22. Of course, these variations may be combined. Similarly, more than two connections may be provided. For example, in the case of a piezoelectric membrane 18 comprising a plurality of portions electrically insulated from one another, or “pixelized” membrane, two electric connections may be provided for each of the piezoelectric membrane portions.

Electric circuit 22 may for example comprise one or a plurality of electronic circuits supplied with electric energy by the microbattery of circuit 22 and processing the electric pulses generated by the piezoelectric membrane and generating data relative thereto. Thus, circuit 22 may for example implement a circuit for counting the number of pulses generated since the tennis ball has been put into service, a function of determination of the average or individual pulse intensity, and/or of determination of the average or individual pulse duration. The data thus generated are for example stored in an internal memory of circuit 22 and/or transmitted by a wireless transmission circuit, for example, by radiofrequency, from circuit 22 to the outside of the ball so that they can be collected. Particularly, knowing the number of pulses enables to know, in addition to the number of impacts received by the ball, the wearing state thereof, since this wearing state particularly directly depends on this number. The number of impacts, their intensity and their duration further are statistical data useful for a player who can then know the strength of its strokes and the type of impact that it applies to the ball, etc. Further, by processing the pulses generated by each portion of a pixelized membrane, it is possible to specify the characteristics of the impacts, their shape, and their mark on the ball.

On recycling of the ball, the electric power storage means of circuit 22 may be discharged to recover the stored energy. Usually, used balls are collected in large numbers and transformed into a rubber lining by means of transformation machines. The electric energy stored in the recycled balls can thus be recovered for the operation of said machines.

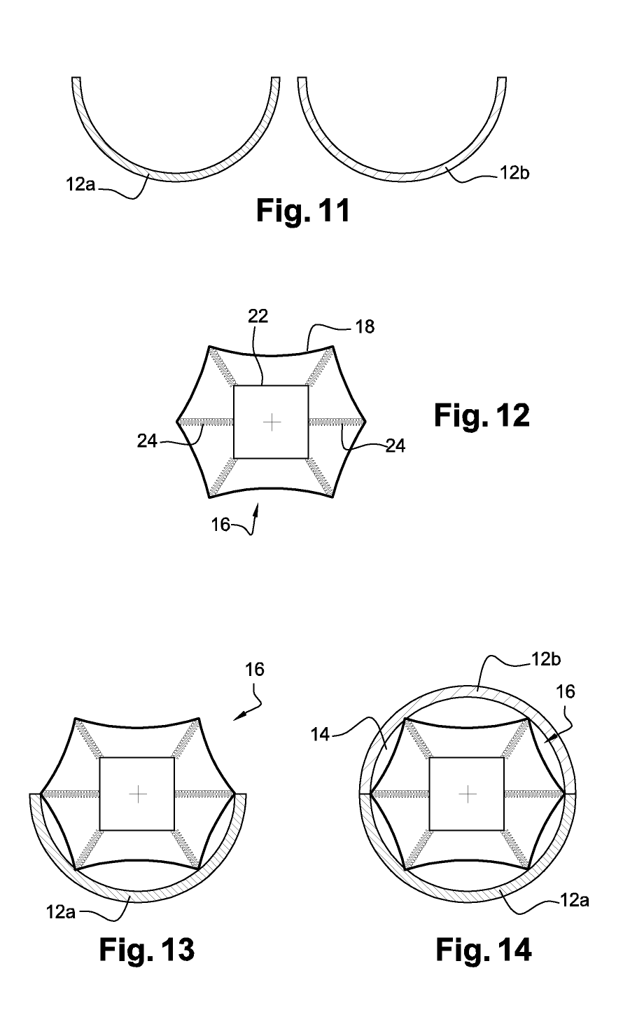

A method of manufacturing the tennis ball just described with now be described in relation with FIGS. 11 to 14.

The method starts by the manufacturing of two hemispherical deformable half-shells 12a and 12b which form shell 12 of ball 10 when they are put together (FIG. 11) and the manufacturing of energy recovery system 16 having holding elements 24 in the form of springs and secured to both piezoelectric membrane 18 and electric circuit 22 (FIG. 12).

Recovery system 16 is then placed in one of half-shells 12a (FIG. 13), after which the other half-shell 12b is fastened to half-shell 12a, particularly by gluing, springs 24 being compressed (FIG. 14).

Finally, inner space 14 of the tennis ball is pressurized, particularly to a 2-bar pressure, which results in deploying the flexible piezoelectric membrane and in applying it against inner wall 20 of ball 10 (FIG. 1).

It should be noted that the manufacturing of the two half-shells and the pressurizing of the ball are for example conventional tennis ball manufacturing steps, the manufacturing of a tennis ball differing from conventional methods by the insertion of energy recovery system 16 into ball 10.

Once the tennis ball is deemed worn out, it is sufficient, in order to recover system 16, to open the ball, the resulting pressure drop being sufficient to separate piezoelectric membrane 18 from shell 12. Since, further, holding elements 24 are not fastened to shell 12, it is then sufficient to grab system 16 to remove it from the ball.

An application of the contemplated embodiments with respect to a tennis ball has been described. Of course, the contemplated embodiments apply to any type of balls having deformable shells, such as for example soccer balls, basketballs, handballs, rugby balls, etc.

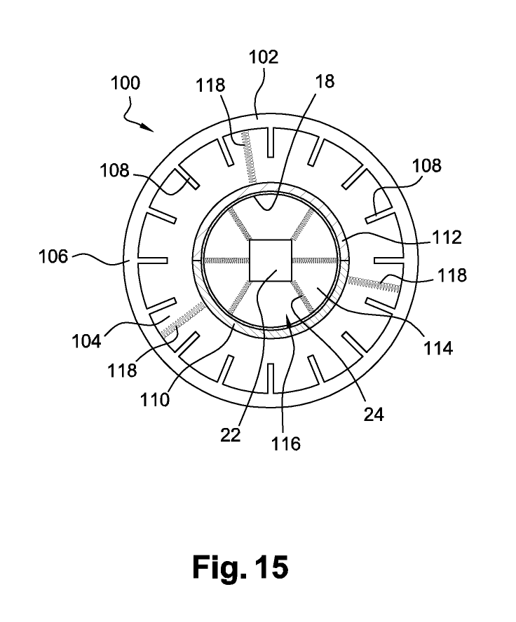

An embodiment applying to an object having a deformable shell is illustrated in simplified cross-section view in FIG. 15.

Such an object 100 comprises a deformable shell 102 defining an inner space 104. Inner space 104 is for example naturally present in the object, for example, a ball. Inner wall 106 of shell 102 is further optionally provided with spikes 108, advantageously regularly distributed on said wall. Finally, an internal object 110, for example, spherical, is provided in inner space 104 and may displace therein.

The internal object comprises a shell 112 defining an inner space 114 under pressure having an energy recovery system 116, similar to previously-described recovery system 16 and especially comprising a piezoelectric membrane such as previously described and placed against the inner surface of shell 110, inserted therein. Shell 112 of object 110 is deformable so that object 110 forms an assembly similar to the above-described tennis ball.

Preferably, spikes 108 are flexible elements or springs, to avoid mechanically damaging the flexible piezoelectric wall.

Object 110 is further fastened to shell 102 by means of resilient holding elements 118, particularly springs, for example, three or four. Holding elements 118 enable to decrease the impact of the presence of internal object 110 on the aerodynamic properties of object 100.

When object 100 receives an impact, it is submitted to an acceleration, and internal object 110 hits shell 102, which thus deforms its shell 112. The piezoelectric membrane applied against the shell thus generates electric charges which are then stored and/or processed in circuit 22 as described hereabove.

Applications to sport have been described. Of course, the described embodiments apply to other types of activity, particularly physical restoration activities which use balls or the like, the statistics generated by such objects enabling the medical staff to study, for example, the quality of the exercises performed by the patients.

What is claimed is:

1. A device comprising a deformable shell defining an inner space under a gas pressure higher than the atmospheric pressure, comprising:
a flexible piezoelectric membrane applied against an inner wall of the deformable shell under the effect of the pressure present in the inner space, said membrane being capable of generating electric energy under the effect of a deformation of the shell;
an electric circuit electrically connected to the piezoelectric membrane, comprising an element for storing the electric energy that said piezoelectric membrane generates and a rigid structure; and
longilineal resilient elements for holding the electric circuit according to a predetermined position of the inner space, each holding element being arranged between the rigid structure of the electric circuit and the inner wall of the deformable shell and being secured to the piezoelectric membrane and to the rigid structure.

2. The device of claim 1, wherein the holding elements comprise springs compressed between the rigid structure of the electric circuit and the inner wall of the deformable shell.

3. The device of claim 1, wherein the deformable shell defines a tennis ball, wherein the predetermined position is the center of the tennis ball, wherein the electric circuit is inscribed within a spherical volume concentric to the tennis ball and having a diameter smaller than half the inner diameter of the deformable shell, wherein the holding elements are deformable with no deterioration over approximately at least one third of the length that they have when the ball is submitted to no deformation.

4. The device of claim 1, wherein the piezoelectric membrane comprises a polyvinylidene fluoride or lead zirconium titanium film.

5. The device of claim 4, wherein the film has a thickness in the range from 10 micrometers to 200 micrometers.

6. The device of claim 1, wherein the electric energy storage element comprises a microbattery formed on a flexible or rigid substrate.

7. The device of claim 1, wherein the holding elements are formed of springs.

8. The device of claim 1, wherein at least two of the holding elements are electrically conductive and form two electric connections between the piezoelectric membrane and the electric circuit for the transmission of the electric energy generated by the membrane to the electric circuit.

9. The device of claim 1, wherein the electric circuit is formed of parallelepipedal electric stages arranged in parallel in a rigid frame.

10. The device of claim 1, wherein the electric circuit comprises a circuit for generating data from the electric energy generated by the piezoelectric membrane, and a circuit of wireless transmission of said data outside of the deformable shell, said generation and transmission circuits being powered by the electric energy storage element.

11. The device of claim 10, wherein the data generation circuit is capable of counting the number of electric pulses generated by the piezoelectric membrane.

12. The device of claim 11, wherein the data generation circuit is capable of determining a wearing state of the device according to the number of counter pulses.

13. A device intended to be integrated in an inner space of a deformable shell taken to a pressure higher than the atmospheric pressure, comprising:
a flexible piezoelectric membrane capable of generating electric energy under the effect of mechanical stress;
an electric circuit electrically connected to the piezoelectric membrane, comprising an element for storing the electric energy that it generates and a rigid structure;
longilineal resilient elements secured to the rigid structure of the electric circuit and secured to the piezoelectric membrane.

14. The device of claim 13, wherein the resilient elements comprise springs.

15. The device of claim 13, wherein the piezoelectric membrane comprises a polyvinylidene fluoride or lead zirconium titanium film.

16. The device of claim 15, wherein the film has a thickness in the range from 10 micrometers to 200 micrometers.

17. The device of claim 13, wherein the electric energy storage element comprises a microbattery formed on a flexible or rigid substrate.

18. The device of claim 13, wherein the resilient elements are formed of springs.

19. The device of claim 13, wherein at least two of the resilient elements are electrically conductive and form two electric connections between the piezoelectric membrane and the electric circuit for the transmission of the electric energy generated by the membrane to the electric circuit.

20. The device of claim 13, wherein the electric circuit is formed of parallelepipedal electric stages arranged in parallel in a rigid frame.

21. The device of claim 13, wherein the electric circuit comprises a circuit for generating data from the electric energy generated by the piezoelectric membrane, and a circuit of wireless transmission of said data, said generation and transmission circuits being powered by the electric energy storage element.

22. The device of claim 21, wherein the data generation circuit is capable of counting the number of electric pulses generated by the piezoelectric membrane.

23. (canceled)

24. A method of manufacturing a device comprising a spherical deformable shell defining an inner space under a gas pressure higher than the atmospheric pressure, comprising:
forming a first and a second deformable half-shells;
forming an assembly comprising the piezoelectric membrane, the electric circuit, and the holding elements, the length of the holding elements being selected so that the latter are compressed when the assembly is housed in the deformable shell;
inserting the assembly into the first half-shell;
placing the second half-shell on the first half-shell to form the deformable shell; and
pressurizing the inner space of the shell to apply the piezoelectric membrane against the inner wall of the deformable shell.
